(19) United States
(12) Patent Application Publication
(10) Pub. No.: US 2009/0100219 A1
(43) Pub. Date: Apr. 16, 2009

(54) METHOD AND APPARATUS FOR EFFICIENT CAM LOOKUP FOR INTERNET PROTOCOL ADDRESSES

(76) Inventor: Anurag Bhargava, Cary, NC (US)

Correspondence Address: ERICSSON INC., 6300 LEGACY DRIVE, M/S EVR 1-C-11, PLANO, TX, 75024, US

(21) Appl. No.: 11/872,300

(22) Filed: Oct. 15, 2007

(51) Int. Cl. G06F 12/04

(52) U.S. Cl. 711/108; 711/E12.015

(57) ABSTRACT

A method and apparatus adapted to perform content addressable memory (CAM) lookup by performing a lookup in parallel using multiple classification rules in the CAM with the same key, wherein the CAM lookup is used to resolve IPv4 and IPv6 addresses.

### STATEMENT REGARDING FEDERALLY SPONSORED RESEARCH OR DEVELOPMENT

NOT APPLICABLE

### REFERENCE TO SEQUENCE LISTING, A TABLE, OR A COMPUTER PROGRAM LISTING COMPACT DISC APPENDIX

NOT APPLICABLE

### BACKGROUND

Unlike standard computer memory, such as random access memory (RAM) in which a memory address is provided and the RAM returns the data word stored at that address, a content addressable memory (CAM) is designed such that when a data word is provided, the CAM searches its entire memory to see if that data word is stored anywhere in it. If the data word is located, the CAM returns a list of one or more storage addresses where the word is located (and in some architecture, it also returns the data word, or other associated pieces of data). Thus, a CAM is a hardware embodiment of an associative array.

CAM is often used in computer networking devices. For example, when a network switch receives a data frame from one of its ports, it updates an internal table with the frame's source media access control (MAC) address and the port it was received on. It then performs a lookup of the destination MAC address in the table to determine what port the frame needs should be forwarded and sends it to that port. The MAC address table is usually implemented with a binary CAM so the destination port can be found very quickly, reducing the switch's latency.

CAMs are often used in network routers, where each address has two parts: the network address, which can vary in size depending on the subnet configuration, and the host address, which occupies the remaining bits. Each subnet has a network mask that specifies which bits of the address are the network address and which bits are the host address. Routing is done by consulting a routing table maintained by the router which contains each known destination network address, the associated network mask, and the information needed to route packets to that destination. Without CAM, the router compares the destination address of the packet to be routed with each entry in the routing table. Using a CAM for the routing table makes the lookup process very efficient as both the masking and comparison are done by the CAM hardware.

Hardware packet filters for firewalls and routers based on CAM allow packet matching processes to keep pace with network throughputs. Internet protocol (IP) quality of service (QoS) solutions rely heavily on CAM hardware classifiers for filtering needs.

IP version 6 (IPv6) addresses which are 128 bit, will require 4 times the CAM entries compared with IP version 4 (IPv4). Combining IPv4 and IPv6 classifiers can be challenging and wasteful of memory space. Conventional filters divide the CAM into two regions: one region for storing IPv4 rules and the other region for storing IPv6 rules. Based on the use of the router and/or firewall, a significant amount of CAM space would not be efficiently used if many of the entries are reserved based on IPv6 classifiers.

What is desired is a method and apparatus whereby an entry of a certain width, e.g., x can be used for routers and firewalls complying with IPv4 rules and an entry of a larger width, such as 2*x, can be used for routers and firewalls complying with IPv6, so that memory is used more efficiently. Such a method and apparatus would permit operation of the filtering priority regardless of the protocol version. In this manner, CAM space would not be split and lookups can be performed at O(1) complexity. In computational complexity theory, big O notation is often used to describe how the size of the input data affects an algorithm's usage of computational resources (in running time or memory). O(1) is considered a constant-time or constant memory space lookup. The present invention provides such a method and apparatus.

### SUMMARY

The method and apparatus of the present invention formats an entry such that IPv4 address has an x width and IPv6 entry has a 2*x width. Whereas, conventionally, entries are added with an action to be taken on a packet if it triggers a certain classification rule, the present invention implements a modified action which will look for further classification rules in the CAM with the same key. Presently, CAM hardware can perform up to 16 lookups in parallel. Such constraints will diminish as new hardware technologies are developed.

### BRIEF DESCRIPTION OF THE SEVERAL VIEWS OF THE DRAWING

In the following section, the invention will be described with reference to exemplary embodiments illustrated in the figures, in which:

FIG. 1 is an IPv4 packet structure;

FIG. 2 is a modified action structure for IPv6 CAM entry;

FIG. 3 is illustrates an IPv6 address Lookup using the present invention; and

FIG. 4 is illustrates another use of the present invention adapted for the IPv6 rules.

### DETAILED DESCRIPTION

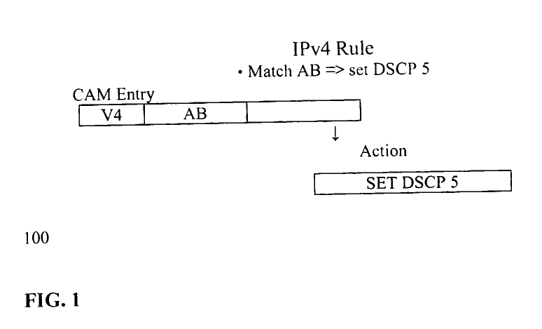

Referring now to FIG. 1, an IPv4 packet 100 with a classification rule to match an IP address to AB with the remark to set the Differentiated Services Code Point (DSCP) to 5. DSCP is a 6-bit field used to identify the level of service a packet receives in the network. This action would result in CAM and fastpath. Hence, if an IPv4 Packet comes with source address equal to AB, it will be classified by CAM and a DSCP value of 5 will be written in the IPv4 packet.

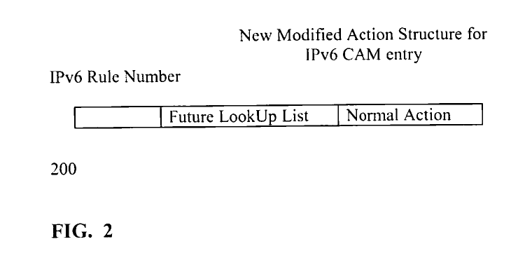

The present invention provides a modified action structure for an IPv6 CAM entry. With the present invention, a CAM lookup can be performed in parallel if multiple rules are able to result in matching criteria, as would be the case where IPv4 and IPv6 co-exist. As noted, IPv4 addresses have a 32 bit address structure, while IPv6 addresses have a 128 bit address structure. Hence, an iPv4 address can easily fit into an IPv6 address structure. As seen in FIG. 2, the new modified action structure 200 of the present invention has more information (Future Lookup List) to trigger a parallel lookup to determine the right match. The normal action will still denote the action to be taken on the matched packet.

Assume an IPv6 classification rule is required to match a packet with address “ABCD” and set its DSCP to 5. “ABCD” will match in two lookups. The first lookup will match “AB” and result would be to continue the lookup with the modified key which has the rest of the address “CD” and rule number 1. The second lookup will result in a match and the appropriate action will be taken. These two lookups result in an IPv6 address match. That is, “ABCD” will be matched in two lookups as one of the two CAM entries are designed to store an IPv6 filter while one stores an IPv4 filter. So two keys will be used—one for “AB” and the other “CD” for finding the right match for the IPv6 address.

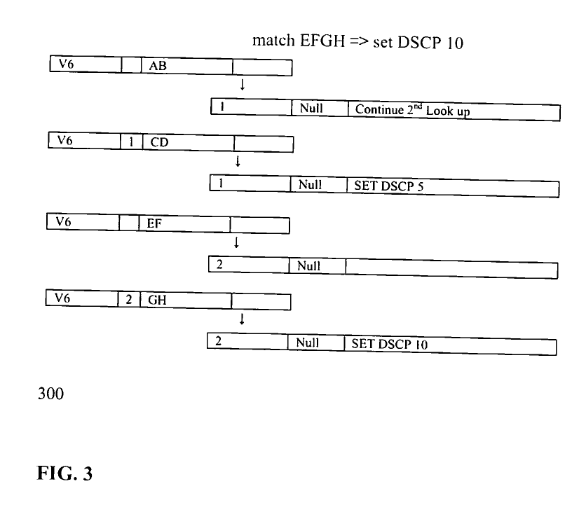

FIG. 3 illustrates actions 300 which occur when another IPv6 rule is added wherein the matching address criterion is “EFGH” and the action is to set DSCP to 10.

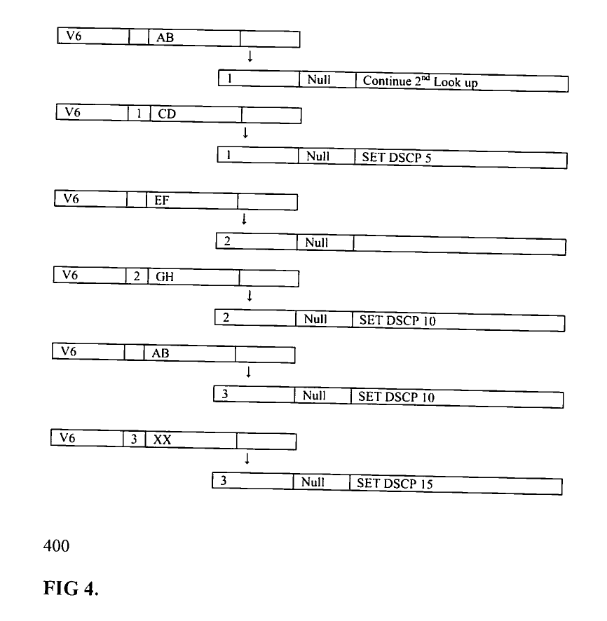

Various scenarios are now discussed to demonstrate the advantages of the present invention and its ability to support both IPv4 and IPv6 filters. Note, from FIG. 3, that packet “ABGH: will not match anything as only those entries will be looked at which will correspond to filter rule 1. To overcome this limitation, FIG. 4 illustrates an extension 400 of the situation by adding another classification rule which provides that “ABXX” is to be matched and DSCP set to 15. As seen therein, the Future lookup List is utilized.

Two CAM entries are added to correspond to rule “ABXX”. Note that “AB” CAM entry has “3” now in the Future Lookup List which indicates that there is another “AB” rule down in the CAM which is identical in all aspects except that it is part of a different IPv6 rule. This Future Lookup List can have more than one element, depending on the number of identical rules. Hence, “ABDE” will match as follows. In step 1, “AB” will match CAM entry 1. The result is rule number 1 and Future Lookup List 3. Then, two keys are prepared: 1, “DE” and 3, “DE”. In step 2, two simultaneous lookups are performed based on the above 2 keys—the first key will result in a miss and the second key will result in a match and the appropriate action will be taken.

As will be recognized by those skilled in the art, the innovative concepts described in the present application can be modified and varied over a wide range of applications. Accordingly, the scope of patented subject matter should not be limited to any of the specific exemplary teachings discussed above, but is instead defined by the following claims.

What is claimed:

1. A method of performing content addressable memory (CAM) lookup, comprising the step of performing a lookup in parallel using multiple classification rules in the CAM with the same key.

2. The method of claim 1, wherein the CAM lookup is used to resolve IPv4 and IPv6 addresses.

3. The method of claim 1, further comprising the step of implementing a modified action which looks for further classification rules in the CAM with the same key.

4. The method of claim 1, adapted to save space in the CAM.

5. The method of claim 1, operable to increase lookup speed.

6. An apparatus adapted to perform content addressable memory (CAM) lookup, comprising, means for performing a lookup in parallel using multiple classification rules in the CAM with the same key.

7. The apparatus of claim 6, wherein the CAM lookup is used to resolve IPv4 and IPv6 addresses.

8. The apparatus of claim 6, further comprising a means adapted to implement a modified action which will look further classification rules in the CAM with the same key.

9. The apparatus of claim 6, adapted to save space in the CAM.

10. The apparatus of claim 16 operable to increase lookup speed of the apparatus.

11. A computer program on a computer readable medium adapted to be loaded into a memory and executed by a processor, comprising computer code adapted to perform content addressable memory (CAM) lookup in parallel using multiple classification rules in the CAM with the same key.

12. The computer program of claim 11, wherein the CAM lookup is used to resolve IPv4 and IPv6 addresses.

13. The computer program of claim 11, further comprising the code adapted to implement a modified action which looks for further classification rules in the CAM with the same key.

14. The computer program of claim 11, adapted to save space in the CAM.

15. The computer program of claim 11 operable to increase lookup speed.
